(19) United States
(12) Patent Application Publication
(10) Pub. No.: US 2025/0015291 A1
(43) Pub. Date: Jan. 9, 2025

(54) POSITIVE ELECTRODE MATERIAL AND BATTERY CONTAINING THE SAME

(71) Applicant: Panasonic Intellectual Property Management Co., Ltd., Osaka (JP)

(72) Inventors: KEITA MIZUNO, Osaka (JP); YOSHIAKI TANAKA, Kyoto (JP); AKIHIRO SAKAI, Nara (JP)

(21) Appl. No.: 18/890,833

(22) Filed: Sep. 20, 2024

Related U.S. Application Data
(63) Continuation of application No. PCT/JP2023/010402, filed on Mar. 16, 2023.

(30) Foreign Application Priority Data
Apr. 6, 2022 (JP) 2022-063644

(51) Int. Cl. H01M 10/0562; H01M 10/052

(52) U.S. Cl. CPC H01M 10/0562; H01M 10/052; H01M 2300/008; H01M 2300/0091

(57) ABSTRACT

A positive electrode material of the present disclosure comprises a positive electrode active material, a first solid electrolyte, and a second solid electrolyte. The first solid electrolyte consists of Li, M1, and X1. The second solid electrolyte consists of Li, M2, O, and X2. M1 is at least one selected from the group consisting of Al, Ti, and Zr. M2 is at least one selected from Group 5 elements. X1 and X2 are each independently at least one selected from the group consisting of F, Cl, Br, and I and comprise F.

### BACKGROUND

### 1. Technical Field

The present disclosure relates to a positive electrode material and a battery including the positive electrode material.

### 2. Description of the Related Art

WO 2020/137153 discloses a solid electrolyte material containing Li, M, O, and X and a battery including the solid electrolyte material. Here, M is at least one element selected from the group consisting of Nb and Ta, and X is at least one element selected from the group consisting of Cl, Br, and I.

WO 2021/075243 discloses a solid electrolyte material containing Li, M, O, X, and F and a battery including the solid electrolyte material. Here, M is at least one element selected from the group consisting of Ta and Nb, and X is at least one element selected from the group consisting of Cl, Br, and I.

WO 2022/004397 discloses a positive electrode material containing a first solid electrolyte containing Li, M1, and F and coating at least part of the surface of a positive electrode active material and a second solid electrolyte containing Li, M2, O, and X. Here, M1 is at least one selected from the group consisting of Ti, Al, and Zr, M2 is at least one selected from the group consisting of Ta and Nb, and X is at least one selected from the group consisting of F, Cl, Br, and I.

### SUMMARY

One non-limiting and exemplary embodiment provides a positive electrode material suitable for improving the charge-discharge characteristics of a battery.

In one general aspect, the techniques disclosed here feature a positive electrode material comprising a positive electrode active material, a first solid electrolyte, and a second solid electrolyte. The first solid electrolyte consists of Li, M1, and X1. The second solid electrolyte consists of Li, M2, O, and X2. M1 is at least one selected from the group consisting of Al, Ti, and Zr. M2 is at least one selected from Group 5 elements. X1 and X2 are each independently at least one selected from the group consisting of F, Cl, Br, and I and comprise F.

The present disclosure provides a positive electrode material suitable for improving the charge-discharge characteristics of a battery.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of a schematic configuration of a positive electrode material according to a first embodiment;

FIG. 2 is a sectional view of a schematic configuration of a positive electrode material according to a modification;

FIG. 3 is a sectional view of a schematic configuration of a battery according to a second embodiment;

FIG. 4 is a schematic diagram of a pressurization molding die used for evaluating the ionic conductivity of a solid electrolyte;

FIG. 5 is a graph of a Cole-Cole plot obtained by electrochemical impedance measurement on a second solid electrolyte of Example 1;

FIG. 6 is a graph of a Cole-Cole plot obtained by electrochemical impedance measurement on a mixed powder of Example 1 at 25° C. before and after 48-hour storage; and

FIG. 7 is a graph of a Cole-Cole plot obtained by electrochemical impedance measurement on a battery of Example 1.

### DETAILED DESCRIPTIONS

### Underlying Knowledge Forming Basis of the Present Disclosure

WO 2020/137153 discloses a solid electrolyte material containing Li, M, O, and X (M is at least one element selected from the group consisting of Nb and Ta, and X is at least one element selected from the group consisting of Cl, Br, and I). WO 2021/075243 discloses a solid electrolyte material containing Li, M, O, X, and F (M is at least one element selected from the group consisting of Ta and Nb, and X is at least one element selected from the group consisting of Cl, Br, and I).

In WO 2020/137153 and WO 2021/075243, the solid electrolyte materials described above are used for a positive electrode to improve the charge-discharge characteristics of a battery.

WO 2022/004397 discloses a positive electrode material containing a positive electrode active material, a solid electrolyte containing fluorine and coating the positive electrode active material, and an oxyhalide solid electrolyte. WO 2022/004397 states that the solid electrolyte containing fluorine has high oxidation stability and can thus inhibit a reaction between the positive electrode active material and another solid electrolyte at a high potential (that is, an oxidatively decomposed layer is less likely to be formed).

However, according to studies by the present inventors, there is a room for improvement in the charge-discharge characteristics of a battery.

The present inventors have conducted intensive studies in order to achieve a battery with improved charge-discharge characteristics. As a result, the present inventors have conceived a positive electrode material of the present disclosure.

### Summary of Aspects According to the Present Disclosure

A positive electrode material according to a first aspect of the present disclosure comprises:
a positive electrode active material;
a first solid electrolyte; and
a second solid electrolyte,
wherein the first solid electrolyte consists of Li, M1, and X1,
the second solid electrolyte consists of Li, M2, O, and X2,
M1 is at least one selected from the group consisting of Al, Ti, and Zr,
M2 is at least one selected from Group 5 elements, and
X1 and X2 are each independently at least one selected from the group consisting of F, Cl, Br, and I and comprise F.

The positive electrode material according to the first aspect is suitable for improving the charge-discharge characteristics of a battery. In addition, because M1 is at least one selected from the group consisting of Al, Ti, and Zr, the lithium ion conductivity of the first solid electrolyte improves.

In a second aspect of the present disclosure, for example, in the positive electrode material according to the first aspect, M2 may comprise Nb. The above configuration improves the lithium ion conductivity of the second solid electrolyte.

In a third aspect of the present disclosure, for example, in the positive electrode material according to the second aspect, M2 may comprise Nb and Ta. The above configuration improves the lithium ion conductivity of the second solid electrolyte.

In a fourth aspect of the present disclosure, for example, in the positive electrode material according to any one of the first to third aspects, X2 may comprise Cl. The above configuration improves the lithium ion conductivity of the second solid electrolyte.

In a fifth aspect of the present disclosure, for example, in the positive electrode material according to any one of the first to fourth aspects, the second solid electrolyte may consist of Li, Ta, Nb, O, Cl, and F. The above configuration improves the lithium ion conductivity of the second solid electrolyte.

In a sixth aspect of the present disclosure, for example, in the positive electrode material according to the second or third aspect, a molar ratio of Nb to M2 may be greater than or equal to 0.50. The above configuration improves the thermodynamic stability of the second solid electrolyte in contact with the first solid electrolyte.

In a seventh aspect of the present disclosure, for example, in the positive electrode material according to the sixth aspect, the molar ratio of Nb to M2 may be greater than or equal to 0.50 and less than or equal to 0.80. The above configuration improves the lithium ion conductivity of the second solid electrolyte.

In an eighth aspect of the present disclosure, for example, in the positive electrode material according to the sixth aspect, the molar ratio of Nb to M2 may be greater than or equal to 0.50 and less than or equal to 0.60. The above configuration further improves the lithium ion conductivity of the second solid electrolyte.

In a ninth aspect of the present disclosure, for example, in the positive electrode material according to any one of the first to eighth aspects, a molar ratio of F to X2 may be greater than or equal to 0.02 and less than or equal to 0.40. The above configuration improves the lithium ion conductivity of the second solid electrolyte.

In a tenth aspect of the present disclosure, for example, in the positive electrode material according to the ninth aspect, the molar ratio of F to X2 may be greater than or equal to 0.02 and less than or equal to 0.08. The above configuration further improves the lithium ion conductivity of the second solid electrolyte.

In an eleventh aspect of the present disclosure, for example, in the positive electrode material according to any one of the first to tenth aspects, the first solid electrolyte may be represented by Composition Formula (1) below:

Li₃₋ₐAl₁₋ₐM3ₐF₆ Formula (1)

wherein M3 is at least one selected from the group consisting of Ti and Zr; and 0<a<1 is satisfied. The above configuration further improves the lithium ion conductivity of the first solid electrolyte.

In a twelfth aspect of the present disclosure, for example, in the positive electrode material according to any one of the first to tenth aspects, the first solid electrolyte may be represented by Composition Formula (2) below:

Li_{6-(4-x-4y+my)b}(Ti_{1-x-y}AlₓM4_{y})_{b}F_{6-2z}O_{z} Formula (2)

wherein M4 is at least one selected from the group consisting of Zr, Ni, Fe, and Cr; m is a valence of M4; and 0.1<x<0.9, 0≤y<0.1, 0≤z<0.1, and 0.8<b≤1.2 are satisfied. The above configuration further improves the lithium ion conductivity of the first solid electrolyte.

In a thirteenth aspect of the present disclosure, for example, in the positive electrode material according to any one of the first to twelfth aspects, the first solid electrolyte may coat at least part of a surface of the positive electrode active material. This configuration can reduce an increase in internal resistance in a positive electrode.

A battery according to a fourteenth aspect of the present disclosure comprises:
a positive electrode comprising the positive electrode material according to any one of the first to thirteenth aspects;
a negative electrode; and
an electrolyte layer provided between the positive electrode and the negative electrode.

The battery according to the fourteenth aspect has excellent charge-discharge characteristics.

Embodiments of the present disclosure will be described below with reference to the drawings.

### First Embodiment

A positive electrode material according to a first embodiment comprises a first solid electrolyte and a second solid electrolyte. The first solid electrolyte consists of Li, M1, and X1. The second solid electrolyte consists of Li, M2, O, and X2. M1 is at least one selected from the group consisting of Al, Ti, and Zr. M2 is at least one selected from Group 5 elements. X1 and X2 are each independently at least one selected from the group consisting of F, Cl, Br, and I and comprise F.

“The first solid electrolyte consists of Li, M1, and X1” means that in the first solid electrolyte, the molar ratio (that is, the molar fraction) of the total of the amounts of substance of Li, M1, and X1 to the total of the amounts of substance of all the elements constituting the first solid electrolyte is greater than or equal to 99%. The first solid electrolyte may consist only of Li, M1, and X1. The same also applies to “the second solid electrolyte consists of Li, M2, O, and X2.”

The positive electrode material according to the first embodiment contains an oxyhalide electrolyte as the second solid electrolyte and thus shows high lithium ion conductivity and shows good initial charge-discharge characteristics. In addition, the positive electrode material according to the first embodiment contains a fluoride solid electrolyte as the first solid electrolyte and thus has excellent oxidation stability. Furthermore, the thermodynamic stability of the first solid electrolyte in contact with the second solid electrolyte is high, and thus the formation of a high-resistance phase by side reactions of the solid electrolytes is inhibited. Consequently, a battery including the positive electrode material according to the first embodiment shows superior cycle characteristics. Thus, the positive electrode material according to the first embodiment can improve the charge-discharge characteristics of the battery.

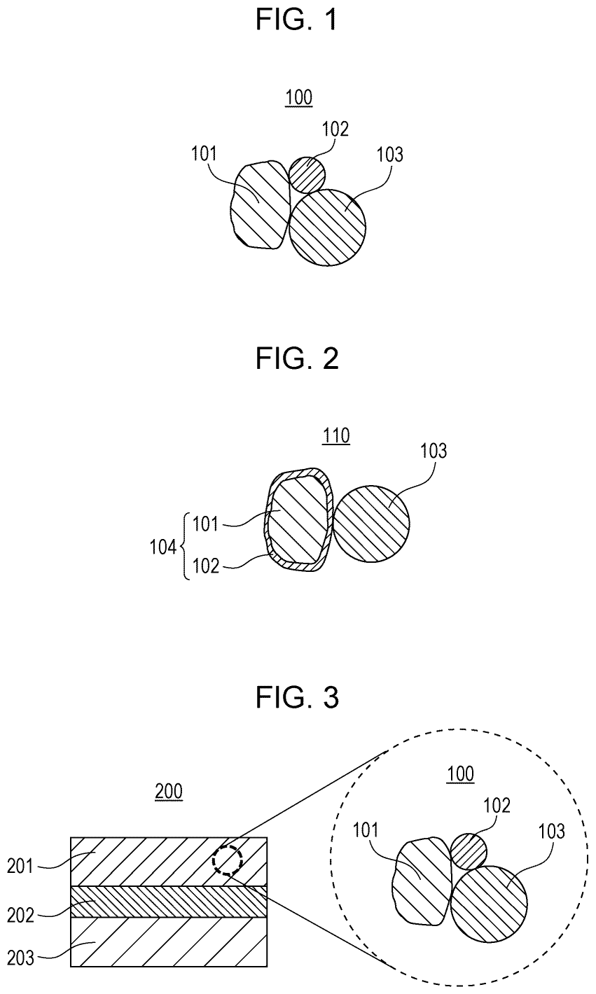

FIG. 1 is a sectional view of a schematic configuration of a positive electrode material 100 according to the first embodiment.

The positive electrode material 100 includes a positive electrode active material 101, a first solid electrolyte 102, and a second solid electrolyte 103.

The positive electrode active material 101 is, for example, in particle form.

In the positive electrode material 100, the first solid electrolyte 102 is interposed between the positive electrode active material 101 and the second solid electrolyte 103.

The first solid electrolyte 102 is, for example, in particle form.

The second solid electrolyte 103 is, for example, in particle form. The second solid electrolyte 103 enables the positive electrode material 100 to have sufficient lithium ion conductivity.

The positive electrode active material 101 is not necessarily in direct contact with the second solid electrolyte 103. This is because the first solid electrolyte 102 interposed between the positive electrode active material 101 and the second solid electrolyte 103 has lithium ion conductivity.

The positive electrode active material 101, the first solid electrolyte 102, and the second solid electrolyte 103 will be described in more detail below.

### Positive Electrode Active Material

Examples of the positive electrode active material 101 include lithium-containing transition metal oxides, transition metal fluorides, polyanionic materials, fluorinated polyanionic materials, transition metal sulfides, transition metal oxyfluorides, transition metal oxysulfides, and transition metal oxynitrides. Examples of the lithium-containing transition metal oxides include Li(Ni,Co,Al)O₂ and LiCoO₂.

In the present disclosure, the expression “(A,B,C)” in chemical formulae means “at least one selected from the group consisting of A, B, and C.” For example, “(Ni,Co,Al)” has the same meaning as “at least one selected from the group consisting of Ni, Co, and Al.”

When the positive electrode active material 101 is in particle form, the particles of the positive electrode active material 101 may have a median diameter of greater than or equal to 0.1 μm and less than or equal to 100 μm. The median diameter means a particle diameter at which a cumulative volume in a volume-based particle size distribution is equal to 50%. The volume-based particle size distribution is measured with, for example, a laser diffraction type measurement apparatus or an image analysis apparatus. When the particles of the positive electrode active material 101 have a median diameter of greater than or equal to 0.1 μm, the positive electrode active material 101, the first solid electrolyte 102, and the second solid electrolyte 103 can be well dispersed in the positive electrode material 100. This improves the charge-discharge characteristics of the battery. When the particles of the positive electrode active material 101 have a median diameter of less than or equal to 100 μm, a lithium diffusion rate within the particles of the positive electrode active material 101 improves. This can allow the battery to operate at high power.

The particles of the positive electrode active material 101 may have a larger median diameter than the particles of the first solid electrolyte 102 and the second solid electrolyte 103. This can allow the particles of the positive electrode active material 101, the first solid electrolyte 102, and the second solid electrolyte 103 to be well dispersed in the positive electrode material 100.

### First Solid Electrolyte

The first solid electrolyte 102 consists of Li, M1, and X1. M1 is at least one selected from the group consisting of Al, Ti, and Zr. Because M1 is at least one selected from the group consisting of Al, Ti, and Zr, the lithium ion conductivity of the first solid electrolyte 102 improves. X1 is at least one selected from the group consisting of F, Cl, Br, and I and comprises F.

With the above configuration, the first solid electrolyte 102 has high oxidation stability, and thus the positive electrode material 100 has excellent oxidation stability. Thus, an increase in the internal resistance of the positive electrode material 100 at a high potential can be reduced, and the charge-discharge characteristics of the battery can be improved.

The first solid electrolyte 102 has high lithium ion conductivity. Here, the high lithium ion conductivity is, for example, greater than or equal to 1.0×10⁻⁷ S/cm. That is, the first solid electrolyte 102 can have a lithium ion conductivity of, for example, greater than or equal to 1.0×10⁻⁷ S/cm. Because M1 is at least one selected from metal elements, the first solid electrolyte 102 can form a cation sublattice suitable for lithium-ion conduction within its crystal lattice. Thus, the first solid electrolyte shows high lithium ion conductivity. Thus, the internal resistance of the positive electrode can be reduced.

The first solid electrolyte 102 may contain elements incidentally mixed therein. Examples of the elements include hydrogen, oxygen, and nitrogen. Such elements can be present in raw material powders of the first solid electrolyte 102 or an atmosphere for producing or storing the first solid electrolyte 102.

To further increase the lithium ion conductivity of the first solid electrolyte 102, the first solid electrolyte 102 may be a material represented by Composition Formula (1) below:

Li₃₋ₐAl₁₋ₐM3ₐF₆ Formula (1)

Here, M3 is at least one selected from the group consisting of Ti and Zr; and 0<a<1 is satisfied.

To further increase the lithium ion conductivity of the first solid electrolyte 102, in Formula (1), 0.2≤a≤0.3 may be satisfied.

To further increase the lithium ion conductivity of the first solid electrolyte 102, in Formula (1), M3 may be Ti, and a=0.3 may be satisfied.

To further increase the lithium ion conductivity of the first solid electrolyte 102, in Formula (1), M3 may be Zr, and a=0.2 may be satisfied.

To further increase the lithium ion conductivity of the first solid electrolyte 102, the first solid electrolyte 102 may be a material represented by Composition Formula (2) below:

Li_{6-(4-x-4y+my)b}(Ti_{1-x-y}AlₓM4_{y})_{b}F_{6-2z}O_{z} Formula (2)

Here, M4 is at least one selected from the group consisting of Zr, Ni, Fe, and Cr; m is a valence of M4; and 0.1<x<0.9, 0<y≤0.1, 0≤z<0.1, and 0.8<b≤1.2 are satisfied.

In Composition Formula (2), when M4 includes a plurality of types of elements, m is the total value of the products of the composition ratios of the individual elements and the valences of the elements. For example, when M4 includes an element Me1 and an element Me2, the composition ratio of the element Me1 is a1, the valence thereof is m1, the composition ratio of the element Me2 is a2, and the valence of the element Me2 is m2, m is represented by m1a1+m2a2.

The first solid electrolyte 102 may be crystalline or amorphous.

The shape of the first solid electrolyte 102 is not limited. Examples of the shape include a needle shape, a spherical shape, and an elliptic spherical shape. The first solid electrolyte 102 may be particles.

When the first solid electrolyte 102 is in particle form (for example, spherical), the solid electrolyte may have a median diameter of greater than or equal to 0.1 μm and less than or equal to 100 μm. When the solid electrolyte has a median diameter in this range, the positive electrode active material 101, the first solid electrolyte 102, and the second solid electrolyte 103 can be well dispersed in the positive electrode material 100.

The median diameter of the first solid electrolyte 102 may be less than or equal to m. In this case, the positive electrode active material 101, the first solid electrolyte 102, and the second solid electrolyte 103 can be well dispersed in the positive electrode material 100.

The median diameter of the first solid electrolyte 102 may be smaller than the median diameter of the positive electrode active material 101. In this case, the positive electrode active material 101, the first solid electrolyte 102, and the second solid electrolyte 103 can be well dispersed in the positive electrode material 100.

In the positive electrode material 100, the content of the first solid electrolyte 102 and the content of the second solid electrolyte 103 may be the same as or different from each other.

### Second Solid Electrolyte

The second solid electrolyte 103 consists of Li, M2, O, and X2. Here, M2 is at least one selected from Group 5 elements. X2 is at least one selected from the group consisting of F, Cl, Br, and I and comprises F.

With the above configuration, the second solid electrolyte 103 has high lithium ion conductivity. That is, the second solid electrolyte 103 can have a lithium ion conductivity of, for example, greater than or equal to 1.0×10⁻⁶ S/cm. Because M2 is at least one selected from Group 5 elements, the second solid electrolyte 103 can form a cation sublattice suitable for lithium-ion conduction within its crystal lattice. Thus, the second solid electrolyte 103 has high lithium ion conductivity. Thus, the internal resistance of the positive electrode material 100 can be reduced.

The second solid electrolyte 103 has high thermodynamic stability in contact with the first solid electrolyte 102. Consequently, an increase in the internal resistance of the positive electrode material 100 is reduced. Thus, the charge-discharge characteristics of the battery improve.

The second solid electrolyte 103 may contain elements incidentally mixed therein. Examples of the elements include hydrogen and nitrogen. Such elements can be present in raw material powders of the second solid electrolyte 103 or an atmosphere for producing or storing the second solid electrolyte 103.

To increase the lithium ion conductivity of the second solid electrolyte 103, M2 may comprise Nb. M2 may be Nb.

To increase the lithium ion conductivity of the second solid electrolyte 103, M2 may comprise Nb and Ta. M2 may be Nb and Ta.

To increase the lithium ion conductivity of the second solid electrolyte 103, X2 may comprise Cl.

To increase the lithium ion conductivity of the second solid electrolyte 103, the second solid electrolyte 103 may consist of Li, Ta, Nb, O, Cl, and F.

To increase the thermodynamic stability of the second solid electrolyte 103 in contact with the first solid electrolyte 102, when M2 comprises Nb, the molar ratio of Nb to M2 (that is, the Nb/M2 molar ratio) may be greater than or equal to 0.50.

To increase the lithium ion conductivity of the second solid electrolyte 103, when M2 comprises Nb, the Nb/M2 molar ratio may be greater than or equal to 0.50 and less than or equal to 0.80.

To further increase the lithium ion conductivity of the second solid electrolyte 103, when M2 comprises Nb, the Nb/M2 molar ratio may be greater than or equal to 0.50 and less than or equal to 0.60.

The upper limit value and the lower limit value of the Nb/M2 molar ratio may be specified by any combination of values selected from 0.50, 0.60, 0.80, and 1.00.

To increase the lithium ion conductivity of the second solid electrolyte 103, the molar ratio of F to X2 (that is, the F/X2 molar ratio) may be greater than or equal to 0.02 and less than or equal to 0.40.

To further increase the lithium ion conductivity of the second solid electrolyte 103, the F/X2 molar ratio may be greater than or equal to 0.02 and less than or equal to 0.08.

The upper limit value and the lower limit value of the F/X2 molar ratio may be specified by any combination of values selected from 0.02, 0.04, 0.06, 0.08, 0.20, and 0.40.

To increase the lithium ion conductivity of the second solid electrolyte 103, the molar ratio of Li to M2 (that is, the Li/M2 molar ratio) may be greater than or equal to 0.60 and less than or equal to 2.4. The molar ratio of O to X2 (that is, the O/X2 molar ratio) may be greater than or equal to 0.16 and less than or equal to 0.35. When the Li/M2 molar ratio is within the above range, the concentration of Li as a conductive carrier can be optimized. When the O/X2 molar ratio is within the above range, a crystalline phase having high ionic conductivity is easily formed. Thus, the lithium ion conductivity of the second solid electrolyte 103 further increases.

To further increase the lithium ion conductivity of the second solid electrolyte 103, the Li/M2 molar ratio may be greater than or equal to 0.86 and less than or equal to 1.25. When the Li/M2 molar ratio is within the above range, the crystalline phase having high ionic conductivity is more easily formed. Thus, the lithium ion conductivity of the second solid electrolyte 103 even further increases.

The second solid electrolyte 103 may be crystalline or amorphous.

The shape of the second solid electrolyte 103 is not limited. Examples of the shape include a needle shape, a spherical shape, and an elliptic spherical shape. The second solid electrolyte 103 may be particles.

When the second solid electrolyte 103 is in particle form (for example, spherical), the solid electrolyte may have a median diameter of greater than or equal to 0.1 μm and less than or equal to 100 μm. When the solid electrolyte has a median diameter in this range, the positive electrode active material 101, the first solid electrolyte 102, and the second solid electrolyte 103 can be well dispersed in the positive electrode material 100.

The median diameter of the second solid electrolyte 103 may be less than or equal to 10 μm. In this case, the positive electrode active material 101, the first solid electrolyte 102, and the second solid electrolyte 103 can be well dispersed in the positive electrode material 100.

The median diameter of the second solid electrolyte 103 may be smaller than the median diameter of the positive electrode active material 101. In this case, the positive electrode active material 101, the first solid electrolyte 102, and the second solid electrolyte 103 can be well dispersed in the positive electrode material 100.

In the positive electrode material 100, the content of the second solid electrolyte 103 may be higher than the content of the first solid electrolyte 102. In this case, the lithium ion conductivity of the positive electrode material 100 increases, and the internal resistance of the battery can be reduced.

### Method for Producing First Solid Electrolyte and Second Solid Electrolyte

The first solid electrolyte 102 and the second solid electrolyte 103 can be produced by, for example, the following method.

First, two or more raw material powders are mixed together so as to have a target composition.

As an example, the target composition is assumed to be Li_{2.7}Ti_{0.3}Al_{0.7}F₆. In this case, raw material powders of LiF, TiF₄, and AlF₃ are mixed together in a molar ratio of about LiF:TiF₄:AlF₃=2.7:0.3:0.7. The raw material powders may be mixed together in a molar ratio adjusted in advance so as to cancel composition changes that can occur in a synthesis process.

Next, the raw material powders are mechanochemically reacted with each other in a mixing device such as a planetary ball mill to obtain a reaction product. That is, the raw material powders are mixed and reacted with each other using a mechanochemical milling method. The thus-obtained reaction product may then be heat-treated in an inert gas atmosphere or in a vacuum.

Alternatively, a mixture of the raw material powders may be reacted by heat treatment in an inert gas atmosphere to obtain a reaction product. Examples of the inert gas include helium, nitrogen, and argon. The heat treatment may be performed in a vacuum. In the heat treatment step, the mixture of the raw material powders may be put in a container (for example, a crucible, a hermetically sealed container, and a vacuum sealed tube) and may be heat-treated in a heating furnace.

By these methods, the first solid electrolyte 102 and the second solid electrolyte 103 according to the first embodiment are obtained.

The composition of the solid electrolytes can be determined by, for example, inductively coupled plasma atomic emission spectroscopy or ion chromatography.

### Method for Producing Positive Electrode Material

By mixing together the positive electrode active material 101, the first solid electrolyte 102, and the second solid electrolyte 103, the positive electrode material 100 is obtained. The method for mixing together the positive electrode active material 101, the first solid electrolyte 102, and the second solid electrolyte 103 is not limited. For example, the positive electrode active material 101, the first solid electrolyte 102, and the second solid electrolyte 103 may be mixed together using a tool such as a mortar.

Alternatively, the positive electrode active material 101, the first solid electrolyte 102, and the second solid electrolyte 103 may be mixed together using a mixing device such as a ball mill. The mixing ratio of the positive electrode active material 101, the first solid electrolyte 102, and the second solid electrolyte 103 is not particularly limited.

### Modification

FIG. 2 is a sectional view of a schematic configuration of a positive electrode material 110 according to a modification.

In the positive electrode material 110, the first solid electrolyte 102 coats at least part of the surface of the positive electrode active material 101 and is thereby interposed between the positive electrode active material 101 and the second solid electrolyte 103. The first solid electrolyte 102 is, for example, in dense film form or in particle form. The positive electrode active material 101 coated with the first solid electrolyte 102 is hereinafter referred to as “coated active material 104.”

In the coated active material 104, the first solid electrolyte 102 may uniformly coat the positive electrode active material 101. In this case, the first solid electrolyte 102 can separate the positive electrode active material 101 and the second solid electrolyte 103 from each other to efficiently inhibit the oxidative decomposition of the second solid electrolyte 103. Consequently, an increase in internal resistance in the positive electrode can be reduced.

In the coated active material 104, the first solid electrolyte 102 may coat only part of the surface of the positive electrode active material 101. That is, the first solid electrolyte 102 may leave part of the surface of the positive electrode active material 101 uncoated. In this case, the particles of the positive electrode active material 101 are in contact with each other via parts not coated with the first solid electrolyte 102, thereby improving electronic conductivity between the particles of the positive electrode active material 101. Consequently, the internal resistance in the positive electrode can be reduced, and the charge-discharge characteristics of the battery can be improved.

In the coated active material 104, the thickness of the first solid electrolyte 102 coating the positive electrode active material 101 may be, for example, greater than or equal to 1 nm and less than or equal to 500 nm.

When the thickness of the first solid electrolyte 102 coating the positive electrode active material 101 is greater than or equal to 1 nm, the positive electrode active material 101 and the second solid electrolyte 103 are separated from each other in the positive electrode material 110, and the oxidative decomposition of the second solid electrolyte 103 can be inhibited. Thus, an increase in internal resistance in the positive electrode can be reduced, and the charge-discharge characteristics of the battery can be improved. When the thickness of the first solid electrolyte 102 coating the positive electrode active material 101 is less than or equal to 500 nm, the positive electrode material 110 can have sufficient electronic conductivity and lithium ion conductivity. Thus, the internal resistance in the positive electrode can be reduced, and the charge-discharge characteristics of the battery can be improved.

The method for measuring the thickness of the first solid electrolyte 102 coating the positive electrode active material 101 is not particularly limited. For example, the thickness of the first solid electrolyte 102 can be measured by observation using a transmission electron microscope or the like.

### Method for Producing Coated Active Material

The coated active material 104 can be produced by, for example, the following method.

A powder of the positive electrode active material 101 and a powder of the first solid electrolyte 102 are provided in a predetermined mass ratio. For example, a powder of Li(Ni,Co,Al)O₂ as the positive electrode active material 101 and a powder of Li_{2.7}Ti_{0.3}Al_{0.7}F₆ as the first solid electrolyte 102 are provided. These two materials are charged into the same reaction vessel, and shear force is applied to the two materials using a rotating blade. Alternatively, the two materials may be caused to collide with each other through a jet airflow. By applying mechanical energy, at least part of the surface of the positive electrode active material 101 can be coated with the first solid electrolyte 102 to produce the coated active material 104.

Before mechanical energy is applied to the mixture of the powder of the positive electrode active material 101 and the powder of the first solid electrolyte 102, the mixture may be subjected to milling processing. For the milling processing, a mixing device such as a ball mill can be used. To inhibit side reactions of the materials, the milling processing may be performed in a dry atmosphere or an inert atmosphere.

The coated active material 104 may be produced by a dry particle composing method. Processing by the dry particle composing method includes applying at least one type of mechanical energy selected from the group consisting of impact, compression, and shear to the positive electrode active material 101 and the first solid electrolyte 102. The positive electrode active material 101 and the first solid electrolyte 102 are mixed together in an appropriate ratio.

The apparatus for use in the production of the coated active material 104 is not particularly limited and can be an apparatus that can apply mechanical energy such as impact, compression, or shear to the mixture of the positive electrode active material 101 and the first solid electrolyte 102. Examples of the apparatus that can apply mechanical energy include ball mills, jet mills, compression shear type processing apparatuses (particle composing apparatuses) such as “Mechano Fusion” (manufactured by Hosokawa Micron Corporation) and “Nobilta” (manufactured by Hosokawa Micron Corporation), and “Hybridization System” (high-speed airflow impact apparatus) (manufactured by Nara Machinery Co., Ltd.).

“Mechano Fusion” is a particle composing apparatus using a dry mechanical composing technique by applying strong mechanical energy to a plurality of particles of different materials. In Mechano Fusion, mechanical energy including compression, shear, and friction is applied to a powder raw material charged into a gap between a rotating vessel and a press head to cause particle composing.

“Nobilta” is a particle composing apparatus using a dry mechanical composing technique as a developed particle composing technique in order to perform composing with nanoparticles as a raw material. Nobilta produces composite particles by applying mechanical energy including impact, compression, and shear to a plurality of raw material powders.

In “Nobilta,” in a horizontal cylindrical mixing vessel, a rotor disposed so as to have a predetermined gap with an inner wall of the mixing vessel rotates at high speed, and processing in which the raw material powders are forcedly passed through the gap is repeated a plurality of times. This exerts the force of impact, compression, and shear on the mixture, and the coated active material 104 can be produced as composite particles of the positive electrode active material 101 and the first solid electrolyte 102. Conditions such as the rotational speed of the rotor, the processing time, and the amounts of materials charged can be adjusted as appropriate.

In “Hybridization System,” while raw material powders are dispersed in a high-speed airflow, force mainly of impact is exerted thereon. Thus, the coated active material 104 is produced as composite particles of the positive electrode active material 101 and the first solid electrolyte 102.

### Method for Producing Positive Electrode Material

By mixing together the coated active material 104 and the second solid electrolyte 103, the positive electrode material 110 is obtained. The method for mixing together the coated active material 104 and the second solid electrolyte 103 is not limited. For example, the coated active material 104 and the second solid electrolyte 103 may be mixed together using a tool such as a mortar.

The coated active material 104 and the second solid electrolyte 103 may be mixed together using a mixing device such as a ball mill. The mixing ratio between the coated active material 104 and the second solid electrolyte 103 is not particularly limited.

### Second Embodiment

A second embodiment will be described below. The features described in the first embodiment may be omitted.

In the second embodiment, a battery including the positive electrode material according to the first embodiment will be described.

The battery according to the second embodiment includes a positive electrode, a negative electrode, and an electrolyte layer. The electrolyte layer is provided between the positive electrode and the negative electrode. The positive electrode contains the positive electrode material according to the first embodiment.

The battery according to the second embodiment includes the positive electrode material according to the first embodiment and thus has excellent charge-discharge characteristics.

The battery may be an all-solid battery.

FIG. 3 is a sectional view of a schematic configuration of a battery 200 according to the second embodiment.

The battery 200 according to the second embodiment includes a positive electrode 201, an electrolyte layer 202, and a negative electrode 203. The electrolyte layer 202 is provided between the positive electrode 201 and the negative electrode 203.

FIG. 3 illustrates, by way of example, a case in which the positive electrode 201 contains the positive electrode material 100 according to the first embodiment. The positive electrode 201 may contain the positive electrode material 110 according to the modification of the first embodiment.

With the above configuration, the internal resistance of the battery 200 can be reduced, thus improving charge-discharge characteristics.

As to the volume ratio “v1:100-v1” of the positive electrode active material 101 to the first solid electrolyte 102 and the second solid electrolyte 103 contained in the positive electrode 201, 30≤v1≤98 may be satisfied. Here, v1 represents the volume ratio of the positive electrode active material 101 when the total volume of the positive electrode active material 101, the first solid electrolyte 102, and the second solid electrolyte 103 contained in the positive electrode 201 is 100. When 30≤v1 is satisfied, the battery 200 can have sufficient energy density. When v1≤98 is satisfied, the battery 200 can be operated at high power.

The thickness of the positive electrode 201 may be greater than or equal to 10 μm and less than or equal to 500 μm. When the thickness of the positive electrode 201 is greater than or equal to 10 μm, the battery 200 can have sufficient energy density. When the thickness of the positive electrode 201 is less than or equal to 500 μm, the battery 200 can be operated at high power.

The electrolyte layer 202 contains an electrolyte. The electrolyte is, for example, a solid electrolyte. The solid electrolyte contained in the electrolyte layer 202 is referred to as “third solid electrolyte”. That is, the electrolyte layer 202 may contain the third solid electrolyte.

The third solid electrolyte may be a halide solid electrolyte or an oxyhalide solid electrolyte. The halide solid electrolyte is a solid electrolyte containing a halogen element such as F, Cl, Br, or I as an anion. The oxyhalide solid electrolyte is a solid electrolyte containing a halogen element such as F, Cl, Br, or I as an anion and containing O (oxygen). As the third solid electrolyte, a solid electrolyte having the same composition as the first solid electrolyte 102 according to the first embodiment or a solid electrolyte having the same composition as the second solid electrolyte 103 may be used. That is, the electrolyte layer 202 may contain a solid electrolyte having the same composition as the first solid electrolyte 102 or contain a solid electrolyte having the same composition as the second solid electrolyte 103.

The third solid electrolyte may be a solid electrolyte having the same composition as the first solid electrolyte 102. That is, the electrolyte layer 202 may contain a solid electrolyte having the same composition as the first solid electrolyte 102.

With the above configuration, the internal resistance of the battery 200 can be reduced, and the charge-discharge characteristics thereof can be further improved.

The third solid electrolyte may be a halide solid electrolyte having a composition different from that of the first solid electrolyte 102 or an oxyhalide solid electrolyte having a composition different from the composition of the second solid electrolyte 103. That is, the electrolyte layer 202 may contain a halide solid electrolyte having a composition different from that of the first solid electrolyte 102 or contain an oxyhalide solid electrolyte having a different composition from the composition of the second solid electrolyte 103.

As an example of the solid electrolyte having a composition different from the composition of the first solid electrolyte 102 and the second solid electrolyte 103, the third solid electrolyte may consist of Li, Y, and X3. Here, X3 is at least one selected from the group consisting of F, Cl, Br, and I.

With the above configuration, the internal resistance of the battery 200 can be reduced, and the charge-discharge characteristics thereof can be further improved.

The third solid electrolyte may be a sulfide solid electrolyte, an oxide solid electrolyte, a polymeric solid electrolyte, or a complex hydride solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂. To the sulfide solid electrolyte, LiX, Li₂O, MO_{q}, LiₚMO_{q}, or the like may be added. X in “LiX” is at least one element selected from the group consisting of F, Cl, Br, and I. M in “MO_{q}” and “LiₚMO_{q}” is at least one selected from the group consisting of P, Si, Ge, B, Al, Ga, In, Fe, and Zn. The letters p and q in “MO_{q}” and “LiₚMO_{q}” are each independently a natural number.

With the above configuration, because the electrolyte layer 202 contains a sulfide solid electrolyte having excellent reduction stability, a negative electrode material with a low potential, such as graphite or metallic lithium, can be used, and the energy density of the battery 200 can be improved.

Examples of the oxide solid electrolyte include NASICON type solid electrolytes such as LiTi₂(PO₄)₃ and element-substituted derivatives thereof, perovskite type solid electrolytes such as (La,Li)TiO₃, LISICON type solid electrolytes such as Li₁₄ZnGe₄O₁₆, Li₄SiO₄, LiGeO₄, and element-substituted derivatives thereof, garnet type solid electrolytes such as Li₇La₃Zr₂O₁₂ and element-substituted derivatives thereof, Li₃PO₄ and N-substituted derivatives thereof, and glasses and glass ceramics based on Li—B—O compounds such as LiBO₂ and Li₃BO₃ and having materials such as Li₂SO₄ and Li₂CO₃ added thereto.

An example of the polymeric solid electrolyte is a compound of a polymer compound with a lithium salt. The polymer compound may have an ethylene oxide structure. A polymer compound having an ethylene oxide structure can contain a large amount of lithium salt and can thus further increase ionic conductivity. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, one lithium salt selected from these may be used singly, or a mixture of two or more lithium salts selected from these may be used.

Examples of the complex hydride solid electrolyte include LiBH₄—LiI and LiBH₄—P₂S₅.

The electrolyte layer 202 may contain the third solid electrolyte as a main component. That is, the electrolyte layer 202 may contain the third solid electrolyte in an amount of, for example, greater than or equal to 50% in terms of mass ratio with respect to the entire electrolyte layer 202 (that is, greater than or equal to 50% by mass).

With the above configuration, the internal resistance of the battery 200 can be reduced, and the charge-discharge characteristics thereof can be further improved.

The electrolyte layer 202 may contain the third solid electrolyte in an amount of greater than or equal to 70% in terms of mass ratio with respect to the entire electrolyte layer 202 (that is, greater than or equal to 70% by mass).

With the above configuration, the charge-discharge characteristics of the battery 200 can be further improved.

The electrolyte layer 202 may further contain incidental impurities, starting raw materials used when the third solid electrolyte is synthesized, byproducts, decomposed products, or the like while containing the third solid electrolyte as the main component.

The electrolyte layer 202 may contain the third solid electrolyte in an amount of, for example, 100% in terms of mass ratio with respect to the entire electrolyte layer 202 except impurities incidentally mixed therein (that is, 100% by mass).

With the above configuration, the charge-discharge characteristics of the battery 200 can be further improved.

As described above, the electrolyte layer 202 may consist only of the third solid electrolyte.

Alternatively, the electrolyte layer 202 may contain two or more of the materials mentioned for the third solid electrolyte. For example, the electrolyte layer 202 may contain a halide solid electrolyte and a sulfide solid electrolyte.

The thickness of the electrolyte layer 202 may be greater than or equal to 1 μm and less than or equal to 300 μm. When the thickness of the electrolyte layer 202 is greater than or equal to 1 μm, the positive electrode 201 and the negative electrode 203 are less likely to be short-circuited. When the thickness of the electrolyte layer 202 is less than or equal to 300 μm, the battery 200 can be operated at high power.

The negative electrode 203 contains a material having the property of occluding and releasing metal ions (for example, lithium ions). The negative electrode 203 contains, for example, a negative electrode active material.

For the negative electrode active material, a metallic material, a carbon material, an oxide, a nitride, a tin compound, a silicon compound, or the like can be used. The metallic material may be an elemental metal. Alternatively, the metallic material may be an alloy. Examples of the metallic material include metallic lithium and lithium alloys. Examples of the carbon material include natural graphite, coke, semi-graphitized carbon, carbon fiber, spherical carbon, artificial graphite, and amorphous carbon. From the viewpoint of capacity density, silicon (Si), tin (Sn), silicon compounds, and tin compounds can be used.

The negative electrode 203 may contain a solid electrolyte. As the solid electrolyte, the solid electrolytes given as examples of the material constituting the electrolyte layer 202 may be used. With the above configuration, lithium ion conductivity inside the negative electrode 203 improves, enabling the battery 200 to be operated at high power.

The median diameter of the particles of the negative electrode active material may be greater than or equal to 0.1 μm and less than or equal to 100 μm. When the median diameter of the particles of the negative electrode active material is greater than or equal to 0.1 μm, the negative electrode active material and the solid electrolyte can be well dispersed in the negative electrode 203. This improves the charge-discharge characteristics of the battery 200. When the median diameter of the particles of the negative electrode active material is less than or equal to 100 μm, lithium diffusion within the negative electrode active material becomes fast. Thus, the battery 200 can be operated at high power.

The median diameter of the particles of the negative electrode active material may be larger than the median diameter of the particles of the solid electrolyte contained in the negative electrode 203. This enables the particles of the negative electrode active material and the particles of the solid electrolyte to be well dispersed in the negative electrode 203.

As to the volume ratio “v2:100-v2” of the negative electrode active material to the solid electrolyte contained in the negative electrode 203, 30≤v2≤95 may be satisfied. Here, v2 represents the volume ratio of the negative electrode active material when the total volume of the negative electrode active material and the solid electrolyte contained in the negative electrode 203 is 100. When 30≤v2, the battery 200 can have sufficient energy density. When v2≤95, the battery 200 can be operated at high power.

The thickness of the negative electrode 203 may be greater than or equal to 10 μm and less than or equal to 500 μm. When the thickness of the negative electrode 203 is greater than or equal to 10 μm, the battery 200 can have sufficient energy density. When the thickness of the negative electrode 203 is less than or equal to 500 μm, the battery 200 can be operated at high power.

At least one selected from the group consisting of the positive electrode 201, the electrolyte layer 202, and the negative electrode 203 may contain a binder for the purpose of improving adhesion between the particles.

Examples of the binder include polyvinylidene fluoride, polytetrafluoroethylene, polyethylene, polypropylene, aramid resins, polyamide, polyimide, polyamideimide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyethersulfone, hexafluoropolypropylene, styrene butadiene rubber, and carboxymethylcellulose. Copolymers can also be used as the binder. Examples of such binders include copolymers of two or more materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. A mixture of two or more selected from the above materials may be used as the binder.

At least one selected from the positive electrode 201 and the negative electrode 203 may contain a conductive aid in order to increase electronic conductivity.

Examples of the conductive aid include:
(i) graphites such as natural graphite and artificial graphite,
(ii) carbon blacks such as acetylene black and ketjen black,
(iii) conductive fibers such as carbon fibers and metallic fibers,
(iv) carbon fluoride,
(v) metallic powders such as aluminum,
(vi) conductive whiskers such as zinc oxide and potassium titanate,
(vii) conductive metal oxides such as titanium oxide, and
(viii) conductive polymer compounds such as polyaniline, polypyrrole, and polythiophene. For reduced costs, the conductive aid (i) or (ii) above may be used.

Examples of the shape of the battery 200 according to the second embodiment include a coin shape, a cylindrical shape, a rectangular shape, a sheet shape, a button shape, a flat shape, and a stacked shape.

The battery 200 according to the second embodiment may be produced by, for example, providing a material for forming the positive electrode, a material for forming the electrolyte layer, and a material for forming the negative electrode and producing a stacked body in which the positive electrode, the electrolyte layer, and the negative electrode are placed on top of each other in this order by a known method.

To improve the power and the energy density of the battery, the battery 200 according to the second embodiment may be charged and discharged at a temperature of higher than or equal to 60° C. That is, a battery system including the battery 200 according to the second embodiment may charge and discharge the battery at a temperature of higher than or equal to 60° C. Because the thermodynamic stability of the first solid electrolyte 102 in contact with the second solid electrolyte 103 is high in the positive electrode, the battery 200 according to the second embodiment has high charge-discharge characteristics even at a temperature higher than room temperature.

### EXAMPLES

The present disclosure will be described in more detail below with reference to examples and comparative examples.

### Example 1

### Production of First Solid Electrolyte

In an argon atmosphere having a dew point of lower than or equal to −60° C. (hereinafter referred to as “dry argon atmosphere”), LiF, TiF₄, and AlF₃ as raw material powders were mixed together in a molar ratio of LiF:TiF₄:AlF₃=2.7:0.3:0.7 to obtain a mixture. Subsequently, using a planetary ball mill (manufactured by Fritsch GmbH, Type P-7), the mixture was subjected to milling processing at 500 rpm for 12 hours. Thus, a powder of a first solid electrolyte of Example 1 was produced. Table 1 lists the constituent elements of the first solid electrolyte of Example 1.

### Production of Second Solid Electrolyte

In a dry argon atmosphere, LiOH, TaCl₅, TaF₅, and NbCl₅ as raw material powders were mixed together in a molar ratio of LiOH:TaCl₅:TaF₅:NbCl₅=0.90:0.46:0.04:0.50 to obtain a mixture. Subsequently, with a planetary ball mill (manufactured by Fritsch GmbH, Type P-7), the mixture was subjected to milling processing at 600 rpm for 12 hours. Next, the processed mixture was heat-treated at 100° C. in a dry argon atmosphere for 1 hour. The obtained heat-treated product was pulverized in an agate mortar. Thus, a powder of a second solid electrolyte of Example 1 was produced.

Table 1 lists the constituent elements of the second solid electrolyte of Example 1.

From the molar ratio of the raw material powders mixed together, the Nb/M2 molar ratio and the F/X2 molar ratio of the second solid electrolyte of Example 1 were calculated. The calculated Nb/M2 molar ratio was 0.50, the calculated F/X2 molar ratio was 0.04, the calculated Li/M2 molar ratio was 0.9, and the calculated O/X2 molar ratio was 0.18. Table 1 lists the calculated values.

### Evaluation of Ionic Conductivity of Second Solid Electrolyte

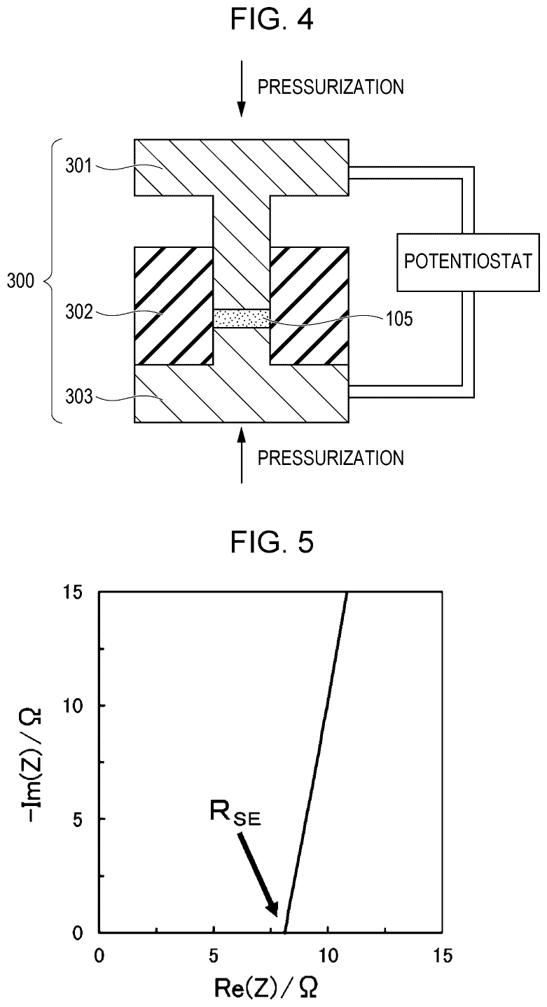

FIG. 4 is a schematic diagram of a pressurization molding die 300 used for evaluating an ionic conductivity of the second solid electrolyte of Example 1.

The pressurization molding die 300 included a punch upper part 301, a die 302, and a punch lower part 303. Both the punch upper part 301 and the punch lower part 303 were formed of an electronically conductive stainless steel. The die 302 was formed of insulating polycarbonate.

Using the pressurization molding die 300 illustrated in FIG. 4, the ionic conductivity of the second solid electrolyte of Example 1 was evaluated by the following method.

In a dry argon atmosphere, a powder 105 of the second solid electrolyte of Example 1 was charged into the pressurization molding die 300. A pressure of 360 MPa was applied to the powder 105 of the second solid electrolyte of Example 1 inside the pressurization molding die 300 using the punch upper part 301 and the punch lower part 303.

With the pressure being applied, the punch upper part 301 and the punch lower part 303 were connected to a potentiostat equipped with a frequency response analyzer (Princeton Applied Research, VersaSTAT4). The punch upper part 301 was connected to a working electrode and a potential measuring terminal. The punch lower part 303 was connected to a counter electrode and a reference electrode. The impedance of the second solid electrolyte was measured by an electrochemical impedance measurement method at room temperature (25° C.).

FIG. 5 is a graph of a Cole-Cole plot obtained by the impedance measurement on the second solid electrolyte of Example 1. The vertical axis shows the imaginary part of complex impedance, and the horizontal axis shows the real part of complex impedance.

In FIG. 5, the real number value of the impedance at a measurement point with the smallest absolute value of the phase of the complex impedance was regarded as a resistance value for the ionic conductivity of the second solid electrolyte. For the real number value, refer to the arrow R_{SE} indicated in FIG. 5. Using the resistance value, the ionic conductivity was calculated based on Equation (2) below:

σ=(R_{SE}×S/t)⁻¹ Equation (2)

Here, a represents the ionic conductivity. S represents the contact area of the second solid electrolyte with the punch upper part 301 (which is equal to the cross-sectional area of the hollow part of the die 302 in FIG. 4). RS_{E} represents the resistance value of the second solid electrolyte in the impedance measurement. The letter t represents the thickness of the second solid electrolyte, that is, in FIG. 4, the thickness of the layer formed of the powder 105 of the second solid electrolyte.

The ionic conductivity of the second solid electrolyte of Example 1 measured at 25° C. was 7.4×10⁻³ S/cm. Table 2 lists the measurement results.

### Production of Mixed Powder of First Solid Electrolyte and Second Solid Electrolyte

In a dry argon atmosphere, the first solid electrolyte and the second solid electrolyte of Example 1 were provided in a volume ratio of 50:50. These materials were mixed together in an agate mortar to obtain a mixed powder. The mixed powder is hereinafter referred to as “mixed powder of Example 1.”

### Evaluation of Reactivity of Mixed Powder

By the following method, the resistance of the mixed powder of Example 1 was measured before and after storage at 60° C. for 48 hours. In this way, the thermodynamic reactivity of the first solid electrolyte and the second solid electrolyte was evaluated.

First, the mixed powder of Example 1 (200 mg) was charged into an insulating tube having an inner diameter of 9.5 mm. Next, a pressure of 360 MPa was applied thereto to form a powder compact of the mixed powder.

Next, current collectors formed of stainless steel were attached to both faces of the powder compact, and current collector leads were attached to the current collectors. Furthermore, using an insulating ferrule, the inside of the insulating tube was insulated from the external atmosphere to hermetically seal the inside of the tube.

Subsequently, the powder compact, with a pressure of 150 MPa being applied thereto, was placed in a thermostatic chamber at 25° C., and the current collector leads were connected to a potentiostat installed with a frequency response analyzer. The two current collectors were each connected to a working electrode and a potential measuring terminal and a counter electrode and a reference electrode. Thus, the impedance of the mixed powder of Example 1 was measured by an electrochemical impedance measurement method.

Subsequently, the temperature of the thermostatic chamber was raised to 60° C., and an impedance of the powder compact of Example 1 was measured in the thermostatic chamber at 60° C.

Subsequently, the powder compact of Example 1 was stored in the thermostatic chamber at 60° C. for 48 hours.

After storage, the impedance of the powder compact of Example 1 was measured in the thermostatic chamber at 60° C.

Subsequently, the temperature of the thermostatic chamber was lowered to 25° C., and the impedance of the powder compact of Example 1 was measured in the thermostatic chamber at 25° C.

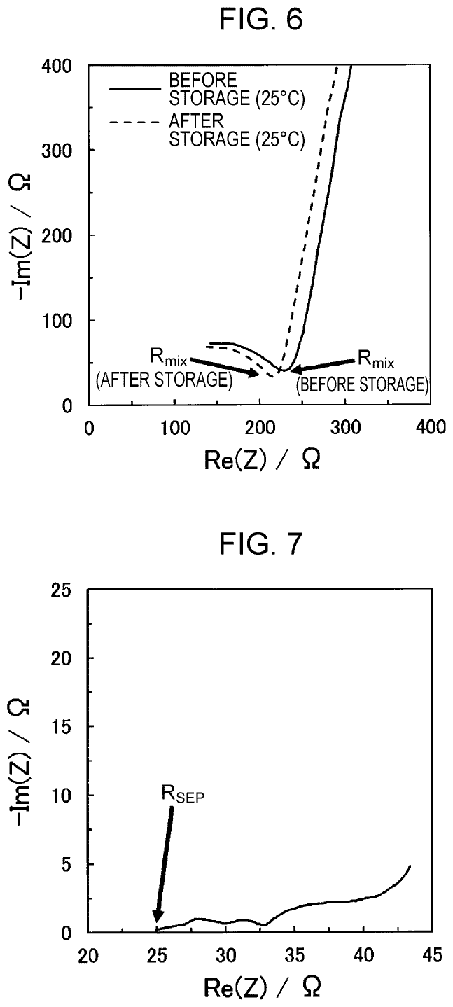

FIG. 6 is a graph of a Cole-Cole plot obtained by the impedance measurement on the powder compact of Example 1 at 25° C. before and after the 48-hour storage. The vertical axis shows the imaginary part of complex impedance, and the horizontal axis shows the real part of complex impedance.

In FIG. 6, the real number value of the impedance at a measurement point with the smallest absolute value of the phase of the complex impedance was regarded as a resistance value Rₘᵢₓ for the ionic conductivity of the powder compact. For the real number value, refer to the arrow Rₘᵢₓ indicated in FIG. 6.

Before and after the 48-hour storage, a resistance change rate of the powder compact of Example 1 at 25° C. and a resistance change rate of the powder compact of Example 1 at 60° C. were each calculated. The resistance change rate of the powder compact was calculated as follows. The resistance value of the powder compact of Example 1 at 25° C. before the 48-hour storage was defined as R_{B}, and the resistance value of the powder compact of Example 1 at 25° C. after the 48-hour storage was defined as R_{F}. In this case, the resistance change rate at 25° C. before and after the 48-hour storage was calculated by R_{F}/R_{B}. The resistance change rate at 60° C. before and after the 48-hour storage was also calculated in the same manner. The resistance change rate of the powder compact of Example 1 at 25° C. was 0.94. The resistance change rate of the powder compact of Example 1 at 60° C. was 0.95. Table 2 lists the resistance change rates.

### Production of Coated Active Material

In a dry argon atmosphere, Li(Ni,Co,Al)O₂ (hereinafter referred to as “NCA”) as a positive electrode active material and the first solid electrolyte of Example 1 were provided in a mass ratio of 100:2.8. These materials were charged into a dry particle composing apparatus Nobilta (manufactured by Hosokawa Micron Corporation) and were subjected to composing processing at 6,000 rpm for 30 minutes. Consequently, a coating layer containing the first solid electrolyte was formed on the surfaces of the particles of the positive electrode active material. Thus, a coated active material of Example 1 was produced.

### Production of Positive Electrode Material

In a dry argon atmosphere, the second solid electrolyte and the coated active material of Example 1 were provided in a volume ratio of 26.6:73.4. These materials were mixed together in an agate mortar to obtain a positive electrode material of Example 1.

### Production of Battery

In an insulating tube having an inner diameter of 9.5 mm, a glass ceramic sulfide solid electrolyte Li₂S—P₂S₅(80 mg, corresponding to a thickness of 600 μm), a halide solid electrolyte Li₃Y₁Br₂Cl₄ (15 mg, corresponding to a thickness of 100 μm), and the above positive electrode material were stacked on top of each other in this order. The mass of the positive electrode material was adjusted such that the amount of NCA contained in the positive electrode material was 7 mg. A pressure of 720 MPa was applied to the obtained stacked body to form a solid electrolyte layer and a positive electrode containing the positive electrode material.

Next, metallic Li (thickness: 200 μm) was stacked on the solid electrolyte layer. A pressure of 80 MPa was applied to the obtained stacked body to obtain a negative electrode.

Next, current collectors formed of stainless steel were attached to the positive electrode and the negative electrode, and current collector leads were attached to the current collectors.

Finally, using an insulating ferrule, the inside of the insulating tube was insulated from the external atmosphere to hermetically seal the inside of the tube. A battery of Example 1 was thus produced.

### Battery Test

By the following method, a DC internal resistance of the electrode before and after a battery cycle test was measured. Thus, the charge-discharge characteristics of the battery were evaluated.

The battery according to Example 1 was placed in a thermostatic chamber at 25° C.

First, the battery of Example 1 was charged at a constant current of 140 μA until a voltage of 4.3 V was reached. The current value corresponds to 0.1 C rate.

Next, the battery of Example 1 was discharged at a constant current of 140 μA until a voltage of 3.785 V was reached. The current value corresponds to 0.1 C rate.

Next, the battery of Example 1 was discharged at a constant voltage of 3.785 V until a current value of 14 μA was reached.

Subsequently, an impedance of the battery of Example 1 was measured by an electrochemical impedance measurement method.

FIG. 7 is a graph of a Cole-Cole plot obtained by the impedance measurement on the battery of Example 1. The vertical axis shows the imaginary part of complex impedance, and the horizontal axis shows the real part of complex impedance.

In FIG. 7, the real number value of the impedance at a measurement point with the smallest absolute value of the phase of the complex impedance was regarded as a resistance value RS_{EP} for the ionic conductivity of the solid electrolyte layer of the battery. For the real number value, refer to the arrow R_{SEP} indicated in FIG. 7.

Subsequently, the battery of Example 1 was discharged at a constant current of 16,800 μA for 10 seconds. In this process, a DC internal resistance R_{DC} of the electrode was calculated using Equation (3) below from a voltage change ΔV before and after discharge, a current value I, and the resistance value R_{SEP} of the solid electrolyte layer. The DC internal resistance R_{DC} calculated in this process is referred to as “DC internal resistance R_{DC1} before charge-discharge cycle.”

R_{DC}=ΔV/I−R_{SEP} Equation (3)

Next, the battery of Example 1 was discharged at a constant current of 140 μA until a voltage of 2.5 V was reached. The current value corresponds to 0.1 C rate.

Next, the battery of Example 1 was placed in a thermostatic chamber at 60° C.

The battery of Example 1 was charged at a constant current of 700 μA until a voltage of 4.3 V was reached. The current value corresponds to 0.5 C rate.

Next, the battery of Example 1 was discharged at a constant current of 2,800 μA until a voltage of 2.5 V was reached. The current value corresponds to 2 C rate.

The above charge and discharge were repeated a total of 100 cycles.

Next, the battery of Example 1 was placed in a thermostatic chamber at 25° C.

The battery of Example 1 was charged at a constant current of 140 μA until a voltage of 4.3 V was reached. The current value corresponds to 0.1 C rate.

Next, the battery of Example 1 was discharged at a constant current of 140 μA until a voltage of 3.785 V was reached. The current value corresponds to 0.1 C rate.

Next, the battery of Example 1 was discharged at a constant voltage of 3.785 V until a current value of 14 μA was reached.

Subsequently, the impedance of the battery of Example 1 was measured by an electrochemical impedance measurement method.

Subsequently, the battery of Example 1 was discharged at a constant current of 16,800 μA for 10 seconds. In this process, the DC internal resistance of the electrode was calculated using Equation (3). The DC internal resistance R_{DC} calculated in this process is referred to as “DC internal resistance R_{DC2} after charge-discharge cycle.”

By calculating the ratio of the DC internal resistance of the electrode before and after the charge-discharge cycle, a resistance change rate of the battery was calculated. Specifically, the ratio (R_{DC2}/R_{DC1}) of the DC internal resistance R_{DC2} after charge-discharge cycle to the DC internal resistance R_{DC1} before charge-discharge cycle was calculated as the resistance change rate of the battery. The resistance change rate of the battery of Example 1 was 2.8. Table 2 lists the resistance change rate of the battery.

### Examples 2 to 10

### Production of First Solid Electrolyte

In Example 10, LiF, ZrF₄, and AlF₃ as raw material powders were mixed together in a molar ratio of LiF:ZrF₄:AlF₃=2.8:0.2:0.8.

A first solid electrolyte of Example 10 was produced in the same manner as in Example 1 except the above.

In Examples 2 to 9, the first solid electrolyte of Example 1 was used as a first solid electrolyte.

### Production of Second Solid Electrolyte

In Example 2, LiOH, TaCl₅, TaF₅, and NbCl₅ as raw material powders were mixed together in a molar ratio of LiOH:TaCl₅:TaF₅:NbCl₅=0.90:0.48:0.02:0.50.

For the second solid electrolyte of Example 2, the calculated Nb/M2 molar ratio was 0.50, the calculated F/X2 molar ratio was 0.02, the calculated Li/M2 molar ratio was 0.9, and the calculated O/X2 molar ratio was 0.18.

In Example 3, LiOH, TaCl₅, TaF₅, and NbCl₅ as raw material powders were mixed together in a molar ratio of LiOH:TaCl₅:TaF₅:NbCl₅=0.90:0.44:0.06:0.50.

For the second solid electrolyte of Example 3, the calculated Nb/M2 molar ratio was 0.50, the calculated F/X2 molar ratio was 0.06, the calculated Li/M2 molar ratio was 0.9, and the calculated O/X2 molar ratio was 0.18.

In Example 4, LiOH, TaCl₅, TaF₅, and NbCl₅ as raw material powders were mixed together in a molar ratio of LiOH:TaCl₅:TaF₅:NbCl₅=0.90:0.16:0.04:0.80.

For the second solid electrolyte of Example 4, the calculated Nb/M2 molar ratio was 0.80, the calculated F/X2 molar ratio was 0.04, the calculated Li/M2 molar ratio was 0.9, and the calculated O/X2 molar ratio was 0.18.

In Example 5, LiOH, TaCl₅, TaF₅, and NbCl₅ as raw material powders were mixed together in a molar ratio of LiOH:TaCl₅:TaF₅:NbCl₅=0.90:0.36:0.04:0.60.

For the second solid electrolyte of Example 5, the calculated Nb/M2 molar ratio was 0.60, the calculated F/X2 molar ratio was 0.04, the calculated Li/M2 molar ratio was 0.9, and the calculated O/X2 molar ratio was 0.18.

In Example 6, LiOH, NbF₅, and NbCl₅ as raw material powders were mixed together in a molar ratio of LiOH:NbF₅:NbCl₅=0.90:0.04:0.96.

For the second solid electrolyte of Example 6, the calculated Nb/M2 molar ratio was 1.00, the calculated F/X2 molar ratio was 0.04, the calculated Li/M2 molar ratio was 0.9, and the calculated O/X2 molar ratio was 0.18.

In Example 7, LiOH, NbF₅, and NbCl₅ as raw material powders were mixed together in a molar ratio of LiOH:NbF₅:NbCl₅=0.90:0.08:0.92.

For the second solid electrolyte of Example 7, the calculated Nb/M2 molar ratio was 1.00, the calculated F/X2 molar ratio was 0.08, the calculated Li/M2 molar ratio was 0.9, and the calculated O/X2 molar ratio was 0.18.

In Example 8, LiOH, NbF₅, and NbCl₅ as raw material powders were mixed together in a molar ratio of LiOH:NbF₅:NbCl₅=0.90:0.2:0.8.

For the second solid electrolyte of Example 8, the calculated Nb/M2 molar ratio was 1.00, the calculated F/X2 molar ratio was 0.2, the calculated Li/M2 molar ratio was 0.9, and the calculated O/X2 molar ratio was 0.18.

In Example 9, LiOH, NbF₅, and NbCl₅ as raw material powders were mixed together in a molar ratio of LiOH:NbF₅:NbCl₅=0.90:0.4:0.6.

For the second solid electrolyte of Example 9, the calculated Nb/M2 molar ratio was 1.00, the calculated F/X2 molar ratio was 0.4, the calculated Li/M2 molar ratio was 0.9, and the calculated O/X2 molar ratio was 0.18.

The second solid electrolytes of Examples 2 to 10 were produced in the same manner as in Example 1 except the above.

Table 1 lists the constituent elements, the Nb/M2 molar ratio, and the F/X2 molar ratio of the second solid electrolytes of Examples 2 to 10.

### Evaluation of Ionic Conductivity of Second Solid Electrolyte

Ionic conductivities of the second solid electrolytes of Examples 2 to 10 were measured in the same manner as in Example 1. Table 2 lists the measurement results.

### Production of Mixed Powder of First Solid Electrolyte and Second Solid Electrolyte

Powder compacts of mixed powders of the first solid electrolytes and the second solid electrolytes of Examples 2 to 10 were obtained in the same manner as in Example 1.

### Evaluation of Reactivity of Mixed Powder

For the powder compacts of Examples 2 to 10, resistance change rates at 25° C. and resistance change rates at 60° C. were each calculated before and after the 48-hour storage in the same manner as in Example 1. Table 2 lists the resistance change rates.

### Comparative Examples 1 and 2

### Production of First Solid Electrolyte

In Comparative Example 2, LiF, ZrF₄, and AlF₃ as raw material powders were mixed together in a molar ratio of LiF:ZrF₄:AlF₃=2.8:0.2:0.8.

A first solid electrolyte of Comparative Example 2 was produced in the same manner as in Example 1 except the above.

In Comparative Example 1, the first solid electrolyte of Example 1 was used as a first solid electrolyte.

### Production of Second Solid Electrolyte

In Comparative Examples 1 and 2, LiOH and TaCl₅ as raw material powders were mixed together in a molar ratio of LiOH:TaCl₅=0.90:1.00.

For a second solid electrolyte of Comparative Examples 1 and 2, the calculated Nb/M2 molar ratio and the calculated F/X2 molar ratio were 0, the calculated Li/M2 molar ratio was 0.9, and the calculated O/X2 molar ratio was 0.18.

The second solid electrolyte of Comparative Examples 1 and 2 was produced in the same manner as in Example 1 except the above.

### Evaluation of Ionic Conductivity of Second Solid Electrolyte

An ionic conductivity of the second solid electrolyte of Comparative Examples 1 and 2 was measured in the same manner as in Example 1. Table 2 lists the measurement results.

### Production of Mixed Powder of First Solid Electrolyte and Second Solid Electrolyte

Powder compacts of mixed powders of the first solid electrolytes and the second solid electrolyte of Comparative Examples 1 and 2 were obtained in the same manner as in Example 1.

### Evaluation of Reactivity of Mixed Powder

For the powder compacts of Comparative Examples 1 and 2, resistance change rates at 25° C. and resistance change rates at 60° C. were each calculated before and after the 48-hour storage in the same manner as in Example 1. Table 2 lists the resistance change rates.

### Production of Positive Electrode Material

A positive electrode material of Comparative Example 1 was obtained in the same manner as in Example 1.

### Production of Battery

A battery of Comparative Example 1 was produced in the same manner as in Example 1.

### Battery Test

A resistance change rate of the battery of Comparative Example 1 was calculated in the same manner as in Example 1. Table 2 lists the resistance change rate of the battery.

### Reference Example 1

### Production of Second Solid Electrolyte

In Reference Example 1, LiOH and TaCl₅ as raw material powders were mixed together in a molar ratio of LiOH:TaCl₅=0.90:1.00. That is, the second solid electrolyte of Reference Example 1 did not contain Nb.

For the second solid electrolyte of Reference Example 1, both the calculated Nb/M2 molar ratio and the calculated F/X2 molar ratio were 0, the calculated Li/M2 molar ratio was 0.9, and the calculated O/X2 molar ratio was 0.18.

The second solid electrolyte of Reference Example 1 was produced in the same manner as in Example 1 except the above.

### Evaluation of Ionic Conductivity of Second Solid Electrolyte

An ionic conductivity of the second solid electrolyte of Reference Example 1 was measured in the same manner as in Example 1. Table 2 lists the measurement results.

### Evaluation of Resistance Increase Rate of Second Solid Electrolyte

A powder compact of the second solid electrolyte of Reference Example 1 was produced in the same manner as in Example 1. Note that the powder compact of Reference Example 1 did not contain the first solid electrolyte. Next, a resistance change rate at 25° C. and a resistance change rate at 60° C. were each calculated before and after the 48-hour storage in the same manner as in Example 1. Table 2 lists the resistance change rates.

TABLE 1

| | First solid | Second solid electrolyte | | |
|---|---|---|---|---|
| | electrolyte | | Nb/M2 | F/X2 |
| | Constituent | Constituent | molar | molar |
| | element | element | ratio | ratio |
| Example 1 | Li, Ti, Al, F | Li, Ta, Nb, O, Cl, F | 0.50 | 0.04 |
| Example 2 | Li, Ti, Al, F | Li, Ta, Nb, O, Cl, F | 0.50 | 0.02 |
| Example 3 | Li, Ti, Al, F | Li, Ta, Nb, O, Cl, F | 0.50 | 0.06 |
| Example 4 | Li, Ti, Al, F | Li, Ta, Nb, O, Cl, F | 0.80 | 0.04 |
| Example 5 | Li, Ti, Al, F | Li, Ta, Nb, O, Cl, F | 0.60 | 0.04 |
| Example 6 | Li, Ti, Al, F | Li, Nb, O, Cl, F | 1.00 | 0.04 |
| Example 7 | Li, Ti, Al, F | Li, Nb, O, Cl, F | 1.00 | 0.08 |
| Example 8 | Li, Ti, Al, F | Li, Nb, O, Cl, F | 1.00 | 0.20 |
| Example 9 | Li, Ti, Al, F | Li, Nb, O, Cl, F | 1.00 | 0.40 |
| Example 10 | Li, Zr, Al, F | Li, Ta, Nb, O, Cl, F | 0.50 | 0.04 |
| Comparative | Li, Ti, Al, F | Li, Ta, O, Cl | 0 | 0 |
| Example 1 | | | | |
| Comparative | Li, Zr, Al, F | Li, Ta, O, Cl | 0 | 0 |
| Example 2 | | | | |
| Reference | — | Li, Ta, O, Cl | 0 | 0 |
| Example1 | | | | |

TABLE 2

| | Ionic | Resistance change rate of | | Resistance |
|---|---|---|---|---|
| | conductivity | powder compact before and | | change |
| | of second solid | after 48-hour storage | | rate of |
| | electrolyte (S/m) | 25° C. | 60° C. | battery |
| Example 1 | 7.4 × 10⁻³ | 0.94 | 0.95 | 2.8 |
| Example 2 | 4.0 × 10⁻³ | 0.99 | 0.97 | — |
| Example 3 | 5.9 × 10⁻³ | 1.00 | 0.83 | — |
| Example 4 | 5.4 × 10⁻³ | 0.89 | 0.90 | — |
| Example 5 | 5.7 × 10⁻³ | 0.98 | 0.90 | — |
| Example 6 | 4.3 × 10⁻³ | 0.74 | 0.85 | — |
| Example 7 | 4.1 × 10⁻³ | 0.78 | 0.89 | — |
| Example 8 | 1.2 × 10⁻⁴ | 0.65 | 0.77 | — |
| Example 9 | 3.1 × 10⁻⁶ | 0.87 | 0.85 | — |
| Example 10 | 7.4 × 10⁻³ | 0.95 | 0.97 | — |
| Comparative | 6.7 × 10⁻³ | 1.21 | 1.08 | 5.4 |
| Example1 | | | | |
| Comparative | 6.7 × 10⁻³ | 1.22 | 1.17 | — |
| Example2 | | | | |
| Reference | 6.7 × 10⁻³ | 0.94 | 0.90 | — |
| Example1 | | | | |

### DISCUSSION

As listed in Table 2, in Comparative Examples 1 and 2, in which the second solid electrolyte did not contain F, the resistance increased after the powder compact of the mixed powder was stored at 60° C. for 48 hours. This probably means that in the mixed powders of Comparative Examples 1 and 2, the first solid electrolyte and the second solid electrolyte reacted with each other, that is, that the thermodynamic stability of the first solid electrolyte in contact with the second solid electrolyte was low. Note that the resistance decreased in Reference Example 1 probably because the powder compact densified during storage.

As listed in Table 2, in Examples 1 to 10, the resistance did not increase after the powder compact of the mixed powder was stored at 60° C. for 48 hours. This probably means that in the mixed powders of Examples 1 to 10, the reaction between the first solid electrolyte and the second solid electrolyte was inhibited, that is, that the thermodynamic stability of the first solid electrolyte in contact with the second solid electrolyte was high. When the second solid electrolyte contains F and Nb, the stability of the crystal lattice of the second solid electrolyte improves. It is believed that this improves the thermodynamic stability of the first solid electrolyte in contact with the second solid electrolyte and thus inhibits the formation of a high-resistance phase at the interface between the solid electrolytes.

As can be seen from, for example, a comparison between Examples 1, 4, and 5 and Example 6, when the Nb/M2 molar ratio was greater than or equal to 0.50 and less than or equal to 0.80, the second solid electrolyte showed a higher ionic conductivity. This is probably because when the Nb/M2 molar ratio is greater than or equal to 0.50 and less than or equal to 0.80, the paths for lithium ions to diffuse are easily formed in the crystals. When the second solid electrolyte is used in the positive electrode material, the ionic conductivity of the positive electrode material further increases, and thus the charge-discharge characteristics of the battery further increase.

As can be seen from, for example, a comparison between Examples 1 and 5 and Example 4, when the Nb/M2 molar ratio was greater than or equal to 0.50 and less than or equal to 0.60, the second solid electrolyte showed an even higher ionic conductivity. This is probably because the paths for lithium ions to diffuse in the crystals are optimized. When the second solid electrolyte is used in the positive electrode material, the ionic conductivity of the positive electrode material even further increases, and thus the charge-discharge characteristics of the battery even further increase.

As can be seen from a comparison between Examples 1 to 7 and Examples 8 and 9, when the F/X2 molar ratio was greater than or equal to 0.02 and less than or equal to 0.08, the second solid electrolyte showed a higher ionic conductivity. This is probably because the paths for lithium ions to diffuse are easily formed in the crystals. When the second solid electrolyte is used in the positive electrode material, the ionic conductivity of the positive electrode material further increases, and thus the charge-discharge characteristics of the battery further increase.

As listed in Table 1, in both Example 1 and Comparative Example 1, the first solid electrolyte contained F. However, as listed in Table 2, Example 1, in which the second solid electrolyte contained Nb, was smaller in the resistance change rate of the battery than Comparative Example 1, in which the second solid electrolyte did not contain Nb. That is, the cycle characteristics of the battery were good. This is probably because, as described above, F and Nb were present in the crystal lattice of the second solid electrolyte, thereby inhibiting the reaction between the first solid electrolyte and the second solid electrolyte and making the high-resistance phase less likely to be formed.

The first solid electrolytes and the second solid electrolytes of Examples 1 to 10 did not contain sulfur. Thus, hydrogen sulfide was not produced even when the first solid electrolytes and the second solid electrolytes of Examples 1 to 10 were used in the positive electrode material.

As described above, the present disclosure can provide a positive electrode material suitable for improving the charge-discharge characteristics of a battery.

The positive electrode material of the present disclosure is used in, for example, batteries (for example, all-solid lithium-ion secondary batteries).

What is claimed is:

1. A positive electrode material comprising:
a positive electrode active material;
a first solid electrolyte; and
a second solid electrolyte,
wherein the first solid electrolyte consists of Li, M1, and X1,
the second solid electrolyte consists of Li, M2, O, and X2,
M1 is at least one selected from the group consisting of Al, Ti, and Zr,
M2 is at least one selected from Group 5 elements, and
X1 and X2 are each independently at least one selected from the group consisting of F, Cl, Br, and I and comprise F.

2. The positive electrode material according to claim 1, wherein M2 comprises Nb.

3. The positive electrode material according to claim 2, wherein M2 comprises Nb and Ta.

4. The positive electrode material according to claim 1, wherein X2 comprises Cl.

5. The positive electrode material according to claim 1, wherein the second solid electrolyte consists of Li, Ta, Nb, O, Cl, and F.

6. The positive electrode material according to claim 2, wherein a molar ratio of Nb to M2 is greater than or equal to 0.50.

7. The positive electrode material according to claim 6, wherein the molar ratio of Nb to M2 is greater than or equal to 0.50 and less than or equal to 0.80.

8. The positive electrode material according to claim 6, wherein the molar ratio of Nb to M2 is greater than or equal to 0.50 and less than or equal to 0.60.

9. The positive electrode material according to claim 1, wherein a molar ratio of F to X2 is greater than or equal to 0.02 and less than or equal to 0.40.

10. The positive electrode material according to claim 9, wherein the molar ratio of F to X2 is greater than or equal to 0.02 and less than or equal to 0.08.

11. The positive electrode material according to claim 1, wherein the first solid electrolyte is represented by Composition Formula (1) below:
Li₃₋ₐAl₁₋ₐM3ₐF₆ Formula (1)
wherein M3 is at least one selected from the group consisting of Ti and Zr; and 0<a<1 is satisfied.

12. The positive electrode material according to claim 1, wherein the first solid electrolyte is represented by Composition Formula (2) below:
Li_{6-(4-x-4y+my)b}(Ti_{1-x-y}AlₓM4_{y})_{b}F_{6-2z}O_{z} Formula (2)
wherein M4 is at least one selected from the group consisting of Zr, Ni, Fe, and Cr; m is a valence of M4; and 0.1<x<0.9, 0≤y<0.1, 0≤z<0.1, and 0.8<b≤1.2 are satisfied.

13. The positive electrode material according to claim 1, wherein the first solid electrolyte coats at least part of a surface of the positive electrode active material.

14. A battery comprising:
a positive electrode comprising the positive electrode material according to claim 1;
a negative electrode; and
an electrolyte layer provided between the positive electrode and the negative electrode.
